(19) United States
(12) Patent Application Publication
(10) Pub. No.: US 2020/0081301 A1
(43) Pub. Date: Mar. 12, 2020

(54) ARRAY SUBSTRATE AND DISPLAY PANEL

(71) Applicant: HKC CORPORATION LIMITED, Shenzhen (CN)

(72) Inventor: Chunhui YANG, CHONGQING (CN)

(21) Appl. No.: 16/312,616

(22) PCT Filed: Nov. 29, 2018
(86) PCT No.: PCT/CN2018/118192

§ 371 Date: Dec. 21, 2018

(30) Foreign Application Priority Data
Sep. 11, 2018 (CN) 201811057899.5

(51) Int. Cl. G02F 1/1337; G02F 1/1339

(52) U.S. Cl. CPC G02F 1/133723; G02F 2001/133776; G02F 1/1339

(57) ABSTRACT

A display panel including: an array substrate including a substrate, an array part disposed on an effective display region of the substrate, and a protective layer and a blocking part both disposed on the surface of the substrate; an opposite substrate including a base layer and a partition feature disposed on the base layer and facing toward the array substrate; a liquid crystal layer; and a sealant disposed between the array substrate and the opposite substrate; wherein the blocking part surrounds the array part, the blocking part has convex and concave surfaces with different heights alternately arranged, the partition feature is disposed corresponding to the blocking part and has convex and concave surfaces with different heights alternately arranged.

The present application claims priority to Chinese Patent Application No. 201811057899.5 filed on Sep. 11, 2018, titled “array substrate and display panel”, the entire disclosure of which is incorporated herein by reference.

### TECHNICAL FIELD

The present application relates to the technical field of display devices, and in particular, to an array substrate and a display panel.

### BACKGROUND

The liquid crystal displays, which are currently widely used, generally have two substrates with a liquid crystal layer interposed therebetween, and a sealant is disposed between the two substrates to bond the two substrates and seal the liquid crystal layer between the two substrates.

In the existing display panel processes, the first process is the alignment layer process. In order to provide a certain alignment for the liquid crystal molecules between the two substrates, an alignment layer (Alignment Layer or Orientation Layer) is provided on each surface of the substrates, and the alignment layer is formed by providing an alignment groove on the alignment layer. After the alignment layer is disposed, a sealant is further provided to join the two substrates.

The alignment layer forming liquid can rotate polyimide (PI), and there are three common coating methods: a soaking mode, a letterpress printing mode, and an ink jetting method. Moreover, as glass sizes have grown, the ink jetting method has become a common means. However, the ink jetting method has problems of blur boundaries, difficulties in reasonably and precisely controlling the accuracy, and further causing poor coating. Therefore, in the processes, a plurality of dummy PS walls (DPSW) and a plurality of grooves are provided in the peripheral regions of the substrates, thereby preventing the alignment layer forming liquid, around the effective display region, from overflowing to the effective display region or the region close to the sealant, when the alignment layer forming liquid is coated on the substrates. However, in the substrate fabricating process in this method, the process of disposing the dummy PS walls in the periphery of the effective display region is added, which not only increases the difficulties of the processes, but also affects the yield of the finished products.

### SUMMARY

An object of the present application is to provide an array substrate, including but not limited to solving the technical problem of high difficulties in the processes of accurately controlling the alignment layer forming liquid when coated at the edge of the substrate.

The technical solutions adopted by the embodiments of the present application are: an array substrate, which includes:

a substrate comprising an effective display region and a frame region;

an array part disposed at least in the effective display region of the substrate; and

a blocking part disposed in the frame region of the substrate, wherein the blocking part surrounds the array part;

wherein the blocking part is provided with convex and concave surfaces with different heights alternately arranged.

In some embodiments, the convex and concave surfaces of the blocking part are provided with a plurality of grooves.

In some embodiments, the shape of the cross section of the plurality of grooves is at least one of a straight line, a broken line, a non-closed curve, a closed curve, a polygon and spokes-like, and the cross section is parallel to the substrate.

In some embodiments, the plurality of grooves are disposed on the surface of the blocking part at equal intervals, unequal intervals or partially equal intervals; wherein the lengths of the plurality of grooves are identical, different or partially identical; the widths of the plurality of grooves are identical, different or partially identical; and the depths of the plurality of grooves are identical, different or partially identical.

In some embodiments, the depth of each of the grooves is less than the thickness of the blocking part.

In some embodiments, the blocking part has a thickness of between 200 mm and 600 mm, the grooves have a depth of between 200 mm and 500 mm, and the grooves have a width of between 0.1 mm and 0.5 mm.

In some embodiments, the edge of the frame region facing away from one lateral side of the effective display region is provided with a sealant, and the blocking part is provided with convex and concave surfaces with different heights arranged alternately, and the convex and concave surfaces is disposed between the sealant and the effective display region.

In some embodiments, the array substrate further comprises a guiding part disposed at a periphery of the array part, and the guiding part and the blocking part have a height difference.

In some embodiments, a partition groove is disposed between the blocking part and the array part, and the guiding part is disposed in the partition groove.

In some embodiments, the guiding part includes a plurality of partition walls and a plurality of openings, and the various partition walls and the various openings are alternately arranged.

In some embodiments, the guiding part comprises a plurality of guiding walls, and the widths of the plurality of guiding walls are identical, different or partially identical; the heights of the plurality of guiding walls are identical, different or partially identical; and the thicknesses of the plurality of guiding walls are identical, different or partially identical.

In some embodiments, the shape of the cross section of the plurality of guiding walls is at least one of a straight line, a broken line, a non-closed curve, a closed curve, a polygon and spokes-like, and the cross section is parallel to the substrate.

In some embodiments, each of the guiding walls has a width of between 10 μm and 300 μm, each of the guiding walls has a height of between 2 μm to 5 μm, and each of the guiding walls has a thickness of between 0.3 μm to 5 μm.

In some embodiments, the array substrate is an active switch array substrate, and the blocking part is made of one or a combination of a metal film, an inorganic insulation film, a transparent conductive film and a semiconductor film disposed on the active switch array substrate.

In some embodiments, the array substrate is a color filter substrate, and the blocking part is made of one or a combination of a color film, a protective film, a black matrix film and a transparent conductive film disposed on the color filter substrate.

In some embodiments, the blocking part and a protective layer of the array substrate are formed in one moulding through using a same material.

Another object of the present application is to provide an array substrate, which includes:

a substrate comprising an effective display region and a frame region arranged to surround the effective display region;

an array part disposed in the effective display region; and

a blocking part disposed in the frame region, wherein the blocking part surrounds the array part;

wherein, the blocking part comprises a plurality of protrusions and a plurality of recesses arranged alternately, a periphery of the array part is provided with a guiding part, the guiding part has a height difference with the blocking part, and a separation groove is disposed between the blocking part and the array part, and the guiding part is disposed in the separation groove.

Still another object of the present application is to provide a display panel, which includes:

an array substrate comprising a substrate, an array part disposed on an effective display region of the substrate, and a protective layer and a blocking part both disposed on the surface of the substrate;

an opposite substrate disposed opposite to the array substrate, comprising a base layer and a partition feature disposed on the base layer and facing toward the array substrate;

a liquid crystal layer disposed between the array substrate and the opposite substrate; and

a sealant disposed between the array substrate and the opposite substrate, wherein the sealant is disposed at a periphery of the liquid crystal layer;

wherein the blocking part surrounds the array part, the blocking part has convex and concave surfaces with different heights alternately arranged, the blocking part and the protective layer are made of the same material, and the blocking part and the protective layer are formed in one moulding; wherein the partition feature is disposed corresponding to the blocking part, and has convex and concave surfaces with different heights alternately arranged.

The display panel provided by the embodiments of the present application improves the accuracy of coating the alignment layer forming liquid through increasing the roughness of the frame region of the array substrate, and easily controls the spillove edge of the forming liquid, thereby facilitating the process control.

### DESCRIPTION OF THE DRAWINGS

In order to more clearly illustrate the technical solutions in the embodiments of the present application, the drawings used in the description of the embodiments or the prior art will be briefly described below. Obviously, the drawings in the following description are only some embodiments of the present application, and other drawings may be obtained based on these drawings for those of ordinary skill in the art without any creative effort.

FIG. 1 is a top view of the substrate of an exemplary liquid crystal display panel.

FIG. 2 is a cross-sectional view showing a blocking part and a guiding part of the array substrate provided by an embodiment of the present application.

FIG. 3 is a schematic view of the groove on the surface of the blocking part provided by an embodiment of the present application.

FIG. 4 is a schematic view of the groove on the surface of the blocking part provided by another embodiment of the present application.

FIG. 5 is a schematic view of the groove on the surface of the blocking part provided by still another embodiment of the present application.

FIG. 6 is a schematic view of an arrangement of the blocking part of the display panel provided by an embodiment of the present application.

FIG. 7 is a cross-sectional view showing a blocking part and a guiding part of the array substrate provided by an embodiment of the present application.

FIG. 8 is a cross-sectional view of the liquid crystal display panel provided by an embodiment of the present application.

### DETAILED DESCRIPTION

In order to make the purposes, technical solutions and advantages of the present application more clear, the present application will be further described in detail below with reference to the accompanying drawings and embodiments. It should be understood that, the specific embodiments described herein are merely illustrative of the application and are not intended to limit the application.

It should be noted that when an element is referred to as being “fixed” to or “disposed” on another element, the element may be directly on the another element or indirectly on the another element. When an element is referred to as being “connected” to another element, the element may be directly or indirectly connected to another element. The orientation or position relationships indicated by the terms such as “on”, “below”, “left”, and “right” and the like are based on the orientation or position relationships shown in the accompanying drawings, and are used only for ease of illustration description, rather than indicating or implying that the mentioned apparatus or component must have a particular orientation or must be constructed or operated in a particular orientation. Therefore, such terms should not be construed as limiting of this patent. A person of ordinary skill in the art can understand the specific meaning of these terms according to specific situations. The terms such as “first” and “second” are used only for the purpose of description, and should not be understood as indicating or implying the relative importance or implicitly specifying the number of the indicated technical features, and “a plurality of” means two or more, unless otherwise specified.

In order to illustrate the technical solutions described in the present application, the present application will be described in detail with reference to specific drawings and embodiments.

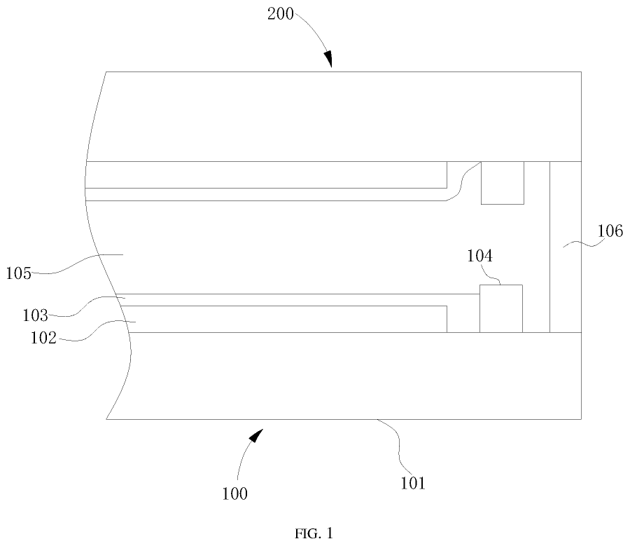

FIG. 1 shows the structure of a cross section of an exemplary liquid crystal display panel. The basic structure of the liquid crystal display panel includes an array substrate 100, an opposite substrate 200, a sealant 106 and a liquid crystal layer 105. The array substrate 100 includes a substrate 101, an array part 102 disposed on the substrate 101, an alignment layer 103 disposed on the array part 102, and a blocking part 104 disposed at the substrate 101 and substantially surrounding the alignment layer 103, wherein the blocking part 104 has a height difference with regard to the surface of the substrate 101. As shown in FIG. 1, the alignment layer 103 is provided by coating an alignment layer forming liquid polyimide (PI) on the array part 102. The blocking part 103 includes several different structures, and may be designed according to different requirements, such as a groove, a partition wall provided by a photo spacer (PS), a color blocking wall in non-display regions, or a physical design consisted of at least one of the three components.

Please continually refer to FIG. 1, the center of the array substrate 100 is an effective display region, which includes a plurality of pixel regions, and each of the pixel regions is configured with a plurality of different color resists, wherein the color resists are different according to the specifications of the display panel, such as three color resists, four color resists or other designs with several color resists. The three color resists are for example respectively a red color resist, a green color resist and a blue color resist, the four color resists are for example respectively a red color resist, a green color resist, a blue color resist and a white color resist. The combination of various color resists may further include a yellow color resist or a color resist for other colors. The material of the color blocking wall in the non-display regions is a red color resist, a blue color resist or a green color resist.

In some embodiments, when the blocking part 103 includes the groove, the partition wall and the color blocking wall in the non-display regions, the color blocking wall in the non-display regions is first coated with the red color resist, the blue color resist or the green color resist during fabricating, the partition wall is coated with a color resist for the partition wall, and the color resists are exposed at the same time. The partition wall is configured on the color blocking wall of the non-display region, and several layers of partition walls may be provided according to the design requirements. The height of the partition wall and the width of the groove are designed to take into account the portion of the multi-coated alignment layer forming liquid caused by the accuracy error of the machine, and the laying dimensions of the partition wall and the groove are accurately determined by calculation, thereby preventing the alignment layer forming liquid around the effective display regions overflowing to the effective display regions or the regions close to the sealant 106 when the array substrate is coated with the alignment layer forming liquid. However, this method, in the substrate fabricating process, adds a process of arranging the partition wall around the effective display region, which not only increases the difficulty in fabricating, but also affects the yield of finished products.

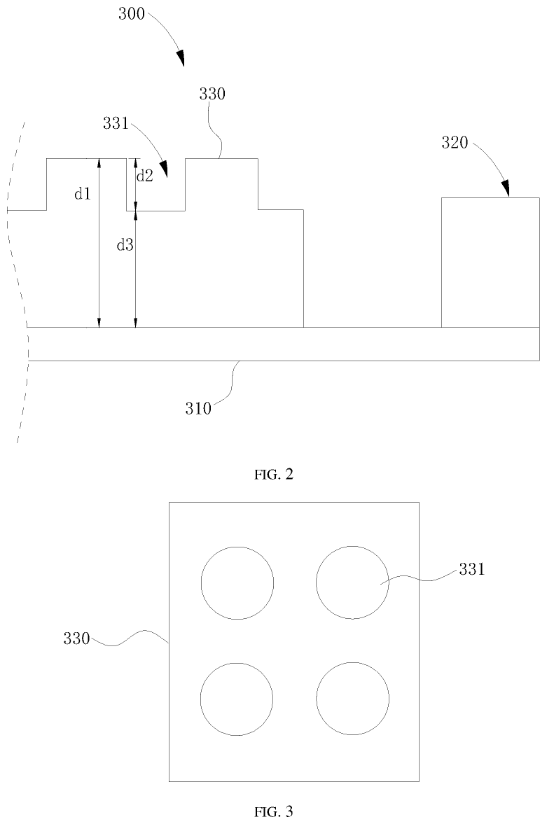

FIG. 2 shows a cross-sectional view of a blocking part and a guiding part of the array substrate in some embodiments of the present application. Please refer to FIG. 2, in some embodiments of the present application, the array substrate 300 includes a substrate 310, an array part 320 disposed in an effective display region of the substrate 310 and corresponding to at least the effective display region, and a blocking part 330 disposed on the surface of the substrate 310 and located in a frame region of the substrate 310, wherein the blocking part 330 surrounds the array part 320, wherein the blocking part 330 has convex and concave surfaces with different heights arranged alternately.

In some embodiments, the array substrate 300 is an active switch array substrate, and the blocking part 330 is made of one or a combination of a metal film, an inorganic insulation film, a transparent conductive film and a semiconductor film disposed on the active switch array substrate.

In some embodiments, the array substrate 300 is a color filter substrate, and the blocking part 330 is made of one or a combination of a color film, a protective film, a black matrix film and a transparent conductive film disposed on the color filter substrate.

In some embodiments, the convex and concave surfaces of the blocking part 330 are provided with a plurality of grooves 331. The plurality of grooves 331 are arranged as a plurality of diversion grooves, to facilitate the flow of the alignment layer forming liquid in the frame region when being coated.

In some embodiments, the plurality of grooves 331 are disposed on the surface of the blocking part 330 in a configuration manner of equal interval, unequal interval, local equal interval or array.

In some embodiments, the lengths of the plurality of grooves 331 are the same, different or locally identical. The widths of the plurality of grooves 331 are the same, different or locally identical. The depths of the plurality of grooves 331 are the same, different or locally identical.

As shown in FIG. 2, in some embodiments, the thickness of the blocking part 330 is d1, the depths of the grooves 331 are d2, and the thickness of the blocking part 330 corresponding to the positions of the plurality of grooves 331 are d3, d1=d2+d3, that is, the depth of each of the grooves 331 is smaller than the thickness of the blocking part 330.

In some embodiments, the blocking part 330 has a thickness between 200 mm and 600 mm, and the grooves have depths between 200 mm and 500 mm.

In some embodiments, the widths of the grooves 331 are between 0.1 mm and 0.5 mm.

In some embodiments, the edge of the frame region facing away from one lateral side of the effective display region is provided with a sealant 510, and the blocking part 330 is provided with convex and concave surfaces with different heights arranged alternately, and the convex and concave surfaces is disposed between the sealant 510 and the effective display region.

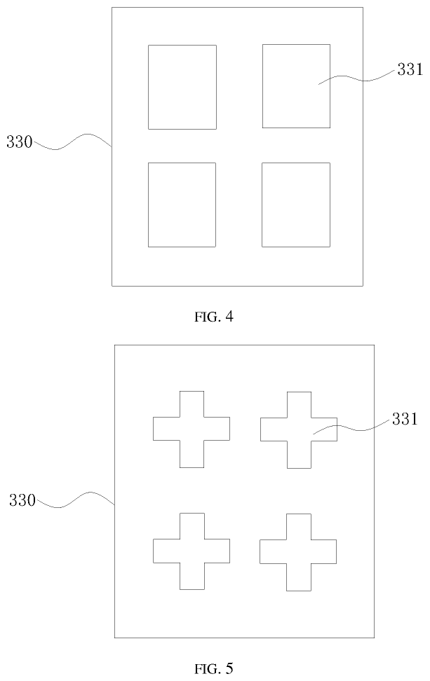

FIGS. 3-5 illustrate the shape of the grooves on the surface of the blocking part in various embodiments of the present application, and the shape of the cross section of the plurality of grooves may be selected from at least one of a circle, a square and a cross, and the cross section is parallel with the substrate 310. In some embodiments, the shape of the plurality of grooves 331 may also be at least one of a straight line, a broken line, a non-closed curve, a closed curve, a polygon and a radial shape, such as one of a semi-arc, a semi-elliptical arc, a square, a circle, an ellipse, a cross, a spokes-like, a torx-like, and an L-like.

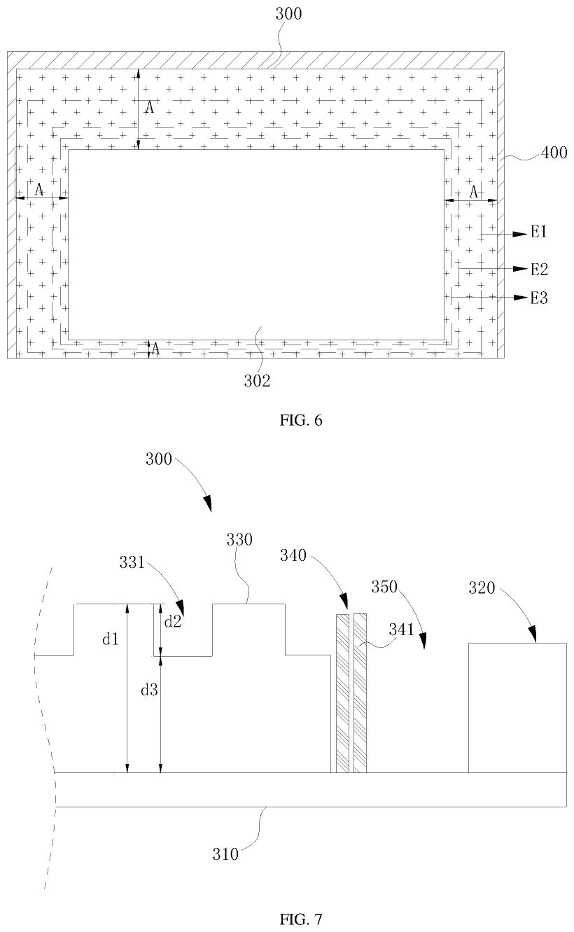

FIG. 6 shows the blocking part of the display panel In some embodiments of the present application. In some embodiments, the pattern of the frame region is specially designed according to the optical mask required by the film layer when the blocking part 330 is fabricated, such as a half-tone mask (HTM), a single-slit mask (SSM), or a gray-tone mask (GTM). Among them, the SSM and the GTM adopt the principle of slit pattern diffraction to reduce the local ultraviolet transmittance, and the HTM uses the semi-permeable membrane on the mask to achieve local ultraviolet light reduction, and thus all achieves the formation of the film layer of the blocking part with different film thicknesses. As shown in FIG. 6, the first edge (E1) in the figure indicates the edge of the forming liquid when the actual alignment layer forming liquid is coated and not overflowed; the third edge E3 indicates the edge of the forming liquid arranged eventually after the actual alignment layer forming liquid is coated and overflowed; and the second edge E2 indicates the edge of the forming liquid arranged eventually after the blocking part 330 is disposed in the frame region (A region), that is, after the roughness of the surface of the substrate is increased, and after the actual alignment layer is coated and overflowed.

FIG. 7 shows a blocking part and a guiding part of the array substrate in some embodiments of the present application. In some embodiments of the present application, the array substrate 300 includes a substrate 310, an array part 320 disposed on the substrate 310, a blocking part 330 disposed at the substrate 310 and surrounding the array part 320, and a guiding part 340 disposed on the periphery of the array part 320 and having a height difference with the blocking part 330.

In some embodiments, the convex and concave surfaces of the blocking part are provided with a plurality of grooves. The guiding part 340 includes a plurality of partition walls and a plurality of openings, and the various partition walls and the various openings are alternately arranged.

In some embodiments, a plurality of separation grooves 350 are disposed between the blocking part 330 and the array part 320, and the guiding part 340 is disposed in corresponding separation groove 350.

In some embodiments, the lengths of the plurality of separation grooves 350 are the same, different or locally identical.

In some embodiments, the depths of the plurality of separation grooves 350 are the same, different or locally identical.

In some embodiments, the depths of the separation grooves 350 are about between 0.4 μm and 1.6 μm.

In some embodiments, the guiding part 340 includes a plurality of guiding walls 341.

In some embodiments, the widths of the plurality of guiding walls 341 are the same, different or locally identical.

In some embodiments, the widths of the guiding walls 341 are about between 10 μm and 300 μm.

In some embodiments, the heights of the plurality of guiding walls 341 are the same, different or locally identical.

In some embodiments, the heights of the guiding walls 341 are about between 2 μm and 5 μm.

In some embodiments, the thicknesses of the plurality of grooves 341 are the same, different or locally identical.

In some embodiments, the thicknesses of the guiding walls 341 are about between 0.3 μm and 5 μm.

In some embodiments, the shape of the cross section of the plurality of grooves 341 is at least one of a straight line, a broken line, a non-closed curve, a closed curve, a polygon and a radial shape, such as one of a semi-arc, a semi-elliptical arc, a square, a circle, an ellipse, a cross, a spokes-like, a torx-like, and an L-like, and the cross section is parallel with the substrate 310.

Please refer to FIGS. 2 and 6, the array substrate provided in some embodiments of the present application includes a substrate 310, an array part 320 and a blocking part 330, wherein the substrate 310 includes an effective display region and a frame region around the effective display region, the array part 320 is disposed in the effective display region, and the blocking part 330 is disposed in the frame region and arranged to surround the array part 320, wherein the blocking part 300 includes a plurality of protrusions and a plurality of recesses alternately arranged, the periphery of the array part 320 is provided with a guiding part 340, and there is a height difference between the guiding part 340 and the blocking part 330, wherein a separation groove 350 is provided between the blocking part 330 and the array part 320, and the guiding part 340 is disposed in the separation groove 350, such that the roughness of the frame region of the substrate is improved, and it is easy to control the spillover edge and the processes when a alignment layer forming fluid is coated in the frame region.

In some embodiments, the guiding part 340 is arranged by a protective layer (Protective Varnish PV). The frame region of the array substrate is provided with a protective layer, and the PV mask at the position of the frame region is specially designed. The PV mask uses such as a half-tone mask (HTM), a single-slit mask (SSM), or a gray-tone mask (GTM). Among them, the SSM mask and the GTM mask adopt the principle of slit pattern diffraction to reduce the local ultraviolet transmittance, and the HTM mask uses the semi-permeable membrane on the mask to achieve local ultraviolet light reduction, and thus all achieves the arrangement of the PV layer with different film thicknesses.

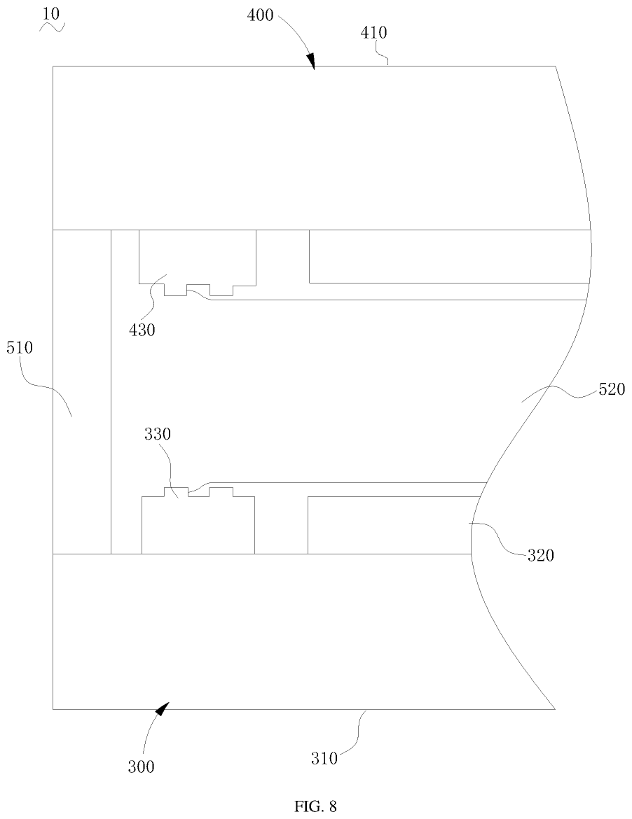

FIG. 8 shows a cross section of the liquid crystal display panel in some embodiments of the present application. Please cooperate with other drawings to facilitate understanding. In some embodiments of the present application, the display panel includes an array substrate 300, an opposite substrate 400 disposed opposite to the array substrate 300, a liquid crystal layer 520 disposed between the array substrate 300 and the opposite substrate 400, and a sealant 510 disposed between the array substrate 300 and the opposite substrate 400 and surrounding the periphery of the liquid crystal layer 520. The array substrate 300 includes a substrate 310, an array part 320 protective layer and a blocking part 330; the array part 320 is disposed in an effective display region of substrate 310, the blocking part 330 is disposed in a frame region of substrate 310, and the blocking part 330 is mainly a protective layer (PV) disposed on the array substrate 300. For example, the blocking part 330 and the protective layer of the array substrate adopt the same material, the blocking part 330 and the protective layer of the array substrate are formed by integral moulding, and the blocking part 330 surrounds the array part 320 and has convex and concave surfaces with different heights alternately arranged. The opposite substrate 400 includes a base layer 410, and a partition feature 430 disposed on the base layer 410 facing toward the array substrate 300. The partition feature 430 corresponds to the blocking part 330, and the partition feature 430 has convex and concave surfaces with different heights alternately arranged, that is, the opposite substrate 400 is also provided with an alignment film, the partition feature 430 arranged can improve the accuracy of coating the alignment layer forming fluid, and the partition feature 430 may has the same or different structure with the blocking part.

Without significantly changing the existing production process, the present application can improve the accuracy of coating the alignment layer forming fluid of the array substrate, easily control the spillover edge of the forming fluid, and facilitate the control of the processes during fabricating the display panel, and further improve the fabrication quality and yield of the display panel. Secondly, the technologies in the present application can be used in the manufacturing of various types of liquid crystal panels with high applicability.

In some embodiments, the display panel of the present application may be, for example, a liquid crystal display panel, but not limited thereto. The display panel may also be an organic light-emitting diode (OLED) display panel, a white light-emitting diode (W-OLED) display panel, a quantum dot light-emitting diode (QLED) display panel, a plasma display panel, a curved display panel or other types of display panels; and the display device may be any product or component with display functions, such as a mobile phone, a tablet computer, a television, a display, a notebook computer, a digital photo frame, or a navigator or the like.

The above is only alternative embodiments of the present application, and is not intended to limit the present application. For those skilled in the art, the application may have various modifications and variations, and any modification, equivalent substitution, improvement, etc. made within the spirit and principles of the present application should be included in the scope of the claims of the present application.

1-18. (canceled)

19. An array substrate, comprising:
a substrate comprising an effective display region and a frame region;
an array part disposed at least in the effective display region of the substrate; and
a blocking part disposed in the frame region of the substrate, wherein the blocking part surrounds the array part;
wherein the blocking part is provided with convex and concave surfaces with different heights alternately arranged.

20. The array substrate according to claim 19, wherein the convex and concave surfaces of the blocking part are provided with a plurality of grooves.

21. The array substrate according to claim 20, wherein the shape of the cross section of the plurality of grooves is at least one of a straight line, a broken line, a non-closed curve, a closed curve, a polygon and spokes-like, and the cross section is parallel to the substrate.

22. The array substrate according to claim 20, wherein the plurality of grooves are disposed on the surface of the blocking part at equal intervals, unequal intervals or partially equal intervals; wherein the lengths of the plurality of grooves are identical, different or partially identical; the widths of the plurality of grooves are identical, different or partially identical; and the depths of the plurality of grooves are identical, different or partially identical.

23. The array substrate according to claim 20, wherein the depth of each of the grooves is less than the thickness of the blocking part.

24. The array substrate according to claim 23, wherein the blocking part has a thickness of between 200 mm and 600 mm, the grooves have a depth of between 200 mm and 500 mm, and the grooves have a width of between 0.1 mm and 0.5 mm.

25. The array substrate according to claim 19, wherein the edge of the frame region facing away from one lateral side of the effective display region is provided with a sealant, and the convex and concave surfaces of the blocking part are disposed between the sealant and the effective display region.

26. The array substrate according to claim 19, wherein the array substrate further comprises a guiding part disposed at a periphery of the array part, and the guiding part and the blocking part have a height difference.

27. The array substrate according to claim 26, wherein a partition groove is disposed between the blocking part and the array part, and the guiding part is disposed in the partition groove.

28. The array substrate according to claim 26, wherein the guiding part comprises a plurality of partition walls and a plurality of openings, and the various partition walls and the various openings are alternately arranged.

29. The array substrate according to claim 26, wherein the guiding part comprises a plurality of guiding walls, and the widths of the plurality of guiding walls are identical, different or partially identical; the heights of the plurality of guiding walls are identical, different or partially identical; and the thicknesses of the plurality of guiding walls are identical, different or partially identical.

30. The array substrate according to claim 29, wherein the shape of the cross section of the plurality of guiding walls is at least one of a straight line, a broken line, a non-closed curve, a closed curve, a polygon and spokes-like, and the cross section is parallel to the substrate.

31. The array substrate according to claim 29, wherein each of the guiding walls has a width of between 10 μm and 300 μm, each of the guiding walls has a height of between 2 μm to 5 μm, and each of the guiding walls has a thickness of between 0.3 μm to 5 μm.

32. The array substrate according to claim 19, wherein the array substrate is an active switch array substrate, and the blocking part is made of one or a combination of a metal film, an inorganic insulation film, a transparent conductive film and a semiconductor film disposed on the active switch array substrate.

33. The array substrate according to claim 19, wherein the array substrate is a color filter substrate, and the blocking part is made of one or a combination of a color film, a protective film, a black matrix film and a transparent conductive film disposed on the color filter substrate.

34. The array substrate according to claim 19, wherein the blocking part and a protective layer of the array substrate are formed in one moulding using a same material.

35. An array substrate, comprising:
a substrate comprising an effective display region and a frame region arranged to surround the effective display region;
an array part disposed in the effective display region; and
a blocking part disposed in the frame region, wherein the blocking part surrounds the array part;
wherein, the blocking part comprises a plurality of protrusions and a plurality of recesses arranged alternately, a periphery of the array part is provided with a guiding part, the guiding part has a height difference relative to the blocking part, and a separation groove is disposed between the blocking part and the array part, and the guiding part is disposed in the separation groove.

36. A display panel, comprising:
an array substrate comprising a substrate, an array part disposed on an effective display region of the substrate, and a protective layer and a blocking part both disposed on the surface of the substrate;
an opposite substrate disposed opposite to the array substrate, comprising a base layer and a partition feature disposed on the base layer and facing toward the array substrate;
a liquid crystal layer disposed between the array substrate and the opposite substrate; and
a sealant disposed between the array substrate and the opposite substrate, wherein the sealant is disposed peripheral of the liquid crystal layer;
wherein the blocking part surrounds the array part, the blocking part has convex and concave surfaces with different heights alternately arranged, the blocking part and the protective layer are made of the same material, and the blocking part and the protective layer are formed in one moulding; wherein the partition feature is disposed corresponding to the blocking part, and has convex and concave surfaces with different heights alternately arranged.
